(19) United States
(12) Patent Application Publication
(10) Pub. No.: US 2014/0313911 A1
(43) Pub. Date: Oct. 23, 2014

(54) APPARATUS AND METHOD FOR CONTROLLING BASIC SERVICE SET AREA

(71) Applicant: ELECTRONICS AND TELECOMMUNICATIONS RESEARCH INSTITUTE, Daejeon-city (KR)

(72) Inventor: Dong-Kyoo KIM, Daejeon (KR)

(73) Assignee: ELECTRONICS AND TELECOMMUNICATIONS RESEARCH INSTITUTE, Daejeon-city (KR)

(21) Appl. No.: 14/208,768

(22) Filed: Mar. 13, 2014

(30) Foreign Application Priority Data
Apr. 17, 2013 (KR) 10-2013-0042490

(51) Int. Cl. H04W 64/00; H04W 24/02

(52) U.S. Cl. CPC H04W 64/003; H04W 24/02
USPC 370/252

(57) ABSTRACT

An apparatus and method for controlling a BSS area are disclosed. The apparatus includes a generation unit, a coordinate extraction unit, a calculation unit, a path loss calculation unit, a characteristic classification unit, a transmitted signal strength calculation unit, and a control unit. The generation unit receives SSIDs, and generates a collected device list. The coordinate extraction unit extracts the coordinates of an SSID corresponding to a specific location beacon device. The calculation unit calculates a straight-line distance between the specific location beacon device and another location beacon device. The path loss calculation unit calculates a measured path loss value. The characteristic classification unit classifies the characteristic of a link. The transmitted signal strength calculation unit calculates transmitted signal strength. The control unit performs control so that a location beacon device other than the specific location beacon device is prevented from operating in a BSS area.

### CROSS REFERENCE TO RELATED APPLICATION

This application claims the benefit of Korean Patent Application No. 10-2013-0042490, filed on Apr. 17, 2013, which is hereby incorporated by reference in its entirety into this application.

### BACKGROUND OF THE INVENTION

1. Technical Field

The present invention relates generally to an apparatus and method for controlling a basic service set (BSS) area and, more particularly, to an apparatus and method for automatically controlling a BSS area for a location beacon device, which are capable of improving the performance of Institute of Electrical and Electronics Engineers (IEEE) 802.11 standards-based location awareness.

2. Description of the Related Art

In general, a location beacon device is a device that wirelessly transmits information required for location awareness, as in a Global Positioning System (GPS) satellite.

In a method of converting a location beacon into information in a location beacon device, a media access control (MAC) address and a service set identification (SSID) are used for a device ID.

A MAC address is a unique 48-bit value that is assigned when a device is manufactured, and is chiefly used as the link layer ID of a network.

In contrast, in a wireless local area network (WLAN) application layer, an SSID is preferred for the identification of a device. For example, an SSID is used to identify a WLAN access point (AP).

Generally, expressions having linguistic meanings, spanning from words, such as a business name or an ID, to sentences, are chiefly used as SSIDs. The reason for this is to enable a human to easily and directly search for devices and select and access a device.

Accordingly, SSIDs are composed of American Standard Code for Information Interchange (ASCII) characters. While SSIDs composed of linguistic terms are advantageous in that they have excellent legibility when humans search for or identify devices, they do not have a variety of uses.

WLAN technology has the main purpose of wirelessly providing Internet service, as in IEEE 802.11a/b/g/n and IEEE 802.11ac/ad.

A WLAN AP is a device that manages a single basic service set (hereinafter referred to as “BSS”) area. WLAN technology is incomplete in terms of methods for an inter-BSS cooperative operation system (for example, multiple BSS management technology, inter-BSS handover technology, intra-BSS terminal management technology, etc.), unlike mobile communication technology. Accordingly, when a WLAN network is deployed, the coverage of each BSS area is made maximally large and the number of access points (APs) (that is, the number of BSS areas) is made small.

U.S. Patent Application Publication No. 2013-0028246 discloses a WLAN-based location measurement system that determines a received signal parameter from at least one received beacon and uses the received signal parameter in order to determine the location of a mobile reception device.

In accordance with the technology disclosed in U.S. Patent Application Publication No. 2013-0028246, when a plurality of APs operates within a limited space, a phenomenon occurs in which there is a serious overlap between BSS areas. However, research into the solution to this problem is insufficient. Since there are many cases where a plurality of location beacon devices operates within a limited space, a problem frequently arises in that the phenomenon of an overlap between BSS areas occurs.

### SUMMARY OF THE INVENTION

Accordingly, the present invention has been made keeping in mind the above problems occurring in the conventional art, and an object of the present invention is to provide an apparatus and method for automatically controlling a BSS area for a location beacon device, which are capable of improving the performance of IEEE 802.11 standards-based location awareness.

In accordance with an aspect of the present invention, there is provided a method of controlling a basic service set (BSS) area, including receiving service set identifications (SSIDs) from location beacon devices, and generating a collected device list based on the received SSIDs; extracting the coordinates of an SSID corresponding to a specific location beacon device in the collected device list; calculating a straight-line distance between the specific location beacon device and another location beacon device using the extracted coordinates of the SSID; calculating a measured path loss value corresponding to the specific location beacon device; classifying a characteristic of a link using the straight-line distance and the measured path loss value; calculating transmitted signal strength using a final collected device list corresponding to the results of the classification of the characteristic of the link; and performing control using the transmitted signal strength so that a location beacon device other than the specific location beacon device is prevented from operating in a BSS area where the specific location beacon device is located.

Performing the control may include setting the specific location beacon device as a representative location beacon device in the BSS area, and performing control so that only the set representative location beacon device operates, thereby preventing another location beacon from transmitting a beacon.

Calculating the measured path loss value may include extracting transmitted signal strength and received signal strength (RSS) corresponding to the specific location beacon device; and calculating the measured path loss value using the extracted transmitted signal strength and the RSS.

Calculating the measured path loss value may include calculating a remainder obtained by subtracting the RSS from the transmitted signal strength as the measured path loss value.

Classifying the characteristic of the link may include classifying the characteristic of the link as a line-of-sight (LOS) link or a non-line-of-sight (NLOS) link.

The SSID may include delimiters indicative of a start and end of a location beacon corresponding to the location beacon device, an encrypt, a unique ID capable of identifying the SSID, an ID of the location beacon device, and a location-related information field.

The location-related information field may be a field in which location-related information is recorded, and may be encrypted in accordance with the encrypt.

The location-related information field may include a collection of groups of an element representative of a type of location-related information and a value representative of a value corresponding to the location-related information.

The element may include transmitted signal strength, antenna gain, antenna type, antenna-front horizontal azimuth angle, antenna antenna-front vertical azimuth angle, spatial information type, a spatial information feature, battery life, and temperature.

The antenna-front horizontal azimuth angle and antenna-front vertical azimuth angle of the element may be used in such a way as to sense information about a direction in which an antenna in the location beacon device has been installed, to sense a change in an azimuth angle based on results of the sensing, and to apply an azimuth angle calibrated using the sensed change to the SSID.

The value may include a size, a semantic value and an ASCII code value conversion method corresponding to the corresponding element.

In accordance with another aspect of the present invention, there is provided an apparatus for controlling a BSS area, including a generation unit configured to receive SSIDs from location beacon devices, and to generate a collected device list based on the received SSIDs; a coordinate extraction unit configured to extract coordinates of an SSID corresponding to a specific location beacon device in the collected device list; a calculation unit configured to calculate a straight-line distance between the specific location beacon device and another location beacon device using the extracted coordinates of the SSID; a path loss calculation unit configured to calculate a measured path loss value corresponding to the specific location beacon device; a characteristic classification unit configured to classify a characteristic of a link using the straight-line distance and the measured path loss value; a transmitted signal strength calculation unit configured to calculate transmitted signal strength using a final collected device list corresponding to results of the classification of the characteristic of the link; and a control unit configured to perform control using the transmitted signal strength so that a location beacon device other than the specific location beacon device is prevented from operating in a BSS area where the specific location beacon device is located.

The control unit may set the specific location beacon device as a representative location beacon device in the BSS area, and may perform control so that only the set representative location beacon device operates, thereby preventing another location beacon from transmitting a beacon.

The apparatus may further include a extraction unit configured to extract transmitted signal strength and RSS corresponding to the specific location beacon device; and wherein the path loss calculation unit calculates the measured path loss value using the transmitted signal strength and RSS extracted by the extraction unit.

The characteristic classification unit may classify the characteristic of the link as an LOS link or an NLOS link.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating a WLAN AP and a beacon transmitted by the WLAN AP according to an embodiment of the present invention;

FIG. 2 is a diagram illustrating a location beacon data format corresponding to an SSID according to an embodiment of the present invention;

FIG. 3 is a diagram illustrating the format of a location-related information field according to an embodiment of the present invention;

FIG. 4 is a diagram illustrating an element and a value in the location-related information field according to an embodiment of the present invention;

FIG. 5 is a diagram illustrating values for spatial information types and spatial information features according to an embodiment of the present invention;

FIG. 6 is a diagram of an azimuth angle transmission device according to an embodiment of the present invention;

FIG. 7 is a flowchart of a method of generating an antenna-front horizontal azimuth angle according to an embodiment of the present invention;

FIG. 8 is a reference diagram illustrating the method of generating an antenna-front horizontal azimuth angle, which is illustrated in FIG. 7;

FIG. 9 is a flowchart of a method of generating an antenna-front vertical azimuth angle according to an embodiment of the present invention;

FIG. 10 is a reference diagram illustrating the method of generating an antenna-front vertical azimuth angle, which is illustrated in FIG. 9;

FIG. 11 is a diagram of a BSS area;

FIG. 12 is a diagram of overlaps between BSS areas;

FIG. 13 is a diagram illustrating the minimization of overlaps between BSS areas;

FIG. 14 is a diagram of an apparatus for automatically controlling a BSS area according to an embodiment of the present invention; and

FIG. 15 is a flowchart illustrating a method of automatically controlling a BSS area according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

An apparatus and method for automatically controlling a BSS area according to embodiments of the present invention will be described in detail below with reference to the accompanying drawings.

First, the present invention is directed to an apparatus and method for automatically controlling a BSS area for a location beacon device that is capable of improving the performance of the IEEE 802.11 standards-based location awareness.

A location beacon device according to an embodiment of the present invention is an IEEE 802.11 standards-based device, and transmits information required for location awareness using the apparatus and method for automatically controlling a BSS area, which are proposed by the present invention.

In the field of location awareness, when information about adjacent WLAN APs is collected in order to analyze RF characteristics at a specific location, “SSIDs” are used to identify the APs about which information has been collected. This means that the SSIDs are used at the level at which a human uses SSIDs when searching for devices.

In the IEEE 802.11 standards, an SSID may be transmitted in a beacon frame or a probe response frame, and may use a maximum 32-byte character string. In this case, the type of character string is not limited, but ASCII code is generally used for character strings. That is, if a character string composed of characters other than ASCII code is used, the possibility of recognition cannot be guaranteed depending on the device.

Accordingly, an ASCII code set should be used for SSIDs in order to guarantee compatibility.

However, a conventional method of using an SSID, which uses linguistic terms using an ASCII code set, has difficulty systematically recording various pieces of information required for location awareness.

The present invention proposes location beacon data format in which various pieces of information required for location awareness are recorded in an ASCII code set that has a very limited range because it supports 7 bits, and also proposes an embodiment of information for location awareness, which should be transmitted by a location beacon device.

In particular, a method of, with regard to a variable element of information for location awareness, incorporating variable information to transmitted location beacon data is proposed.

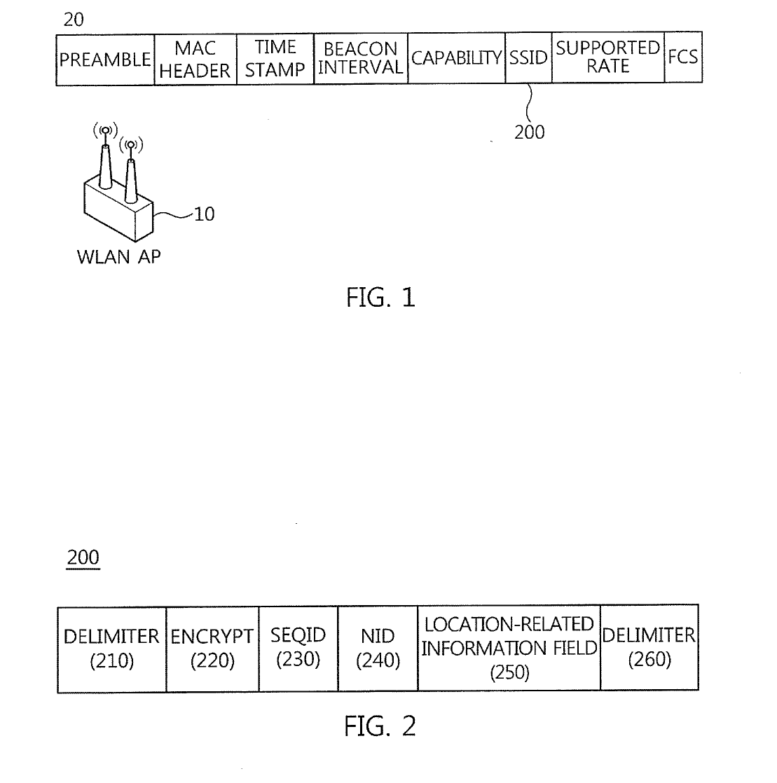

FIG. 1 is a diagram illustrating a WLAN AP and a beacon transmitted by the WLAN AP according to an embodiment of the present invention.

Referring to FIG. 1, in the IEEE 802.11 standards, a WLAN AP 10 transmits a beacon 20. In this case, the beacon 20 includes a preamble, a MAC header, a time stamp, a beacon interval, capability, an SSID 200, a supported rate, and a frame check sequence (FCS).

Next, in the beacon 20, a location beacon data format corresponding to the SSID 200 will be described in detail below with reference to FIG. 2.

FIG. 2 is a diagram illustrating a location beacon data format corresponding to the SSID according to an embodiment of the present invention.

Referring to FIG. 2, the SSID 200 includes delimiters 210 and 260, an encrypt 220, a SEQ ID 230, an NID 240, and a location-related information field 250.

The delimiters 210 and 260 are fields indicative of the start and end of the location beacon in the SSID 200. For example, the delimiters 210 and 260 may uniquely use 0×21 that belongs to ASCII codes having a length of 1 byte.

The encrypt 220 has a length of 1 byte, and is indicative of whether the location-related information field 250 has been encrypted or an encryption method.

The SEQ ID 230 corresponds to a unique ID that is capable of identifying the SSID 200. That is, a single location beacon device may use a plurality of SSIDs, in which case the SEQ ID 230 having a length of 1 byte is used to identify each of the SSIDs.

The NID 240 corresponds to the ID of the location beacon device.

The location-related information field 250 is a field in which location-related information is recorded, and may be encrypted in accordance with the encrypt 220.

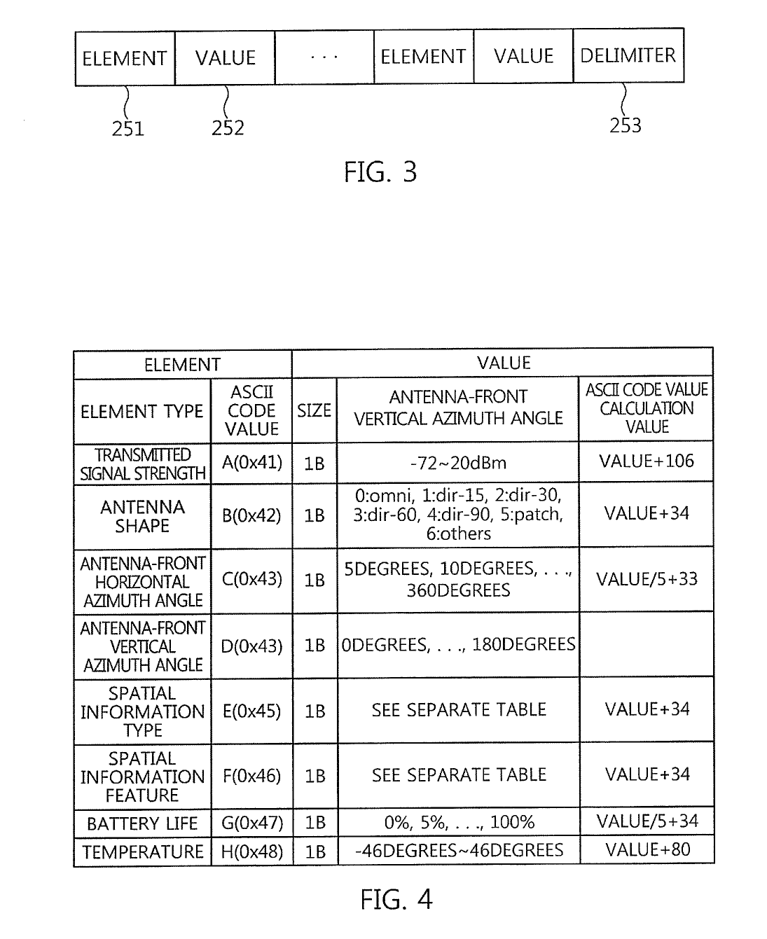

Next, the format of the location-related information field 250 will be described in detail below with reference to FIG. 3.

FIG. 3 is a diagram illustrating the format of the location-related information field according to an embodiment of the present invention.

Referring to FIG. 3, the location-related information field 250 includes a collection of groups of an element 251 representative of the type of location-related information and a value 252 representative of a value corresponding to the location-related information.

Furthermore, the location-related information field 250 includes a delimiter 253 indicative of the end of the location-related information field.

The length of the element 251 is 1 byte, and the length of the value 252 is defined by a user based on a corresponding element.

While the delimiter 253 may use the same value as the delimiters 210 and 260 of FIG. 2, the present invention is not limited thereto.

Next, the element 251 and the value 252 in the format of the location-related information field will be described in detail below with reference to FIG. 4.

FIG. 4 is a diagram illustrating the element and the value in the location-related information field according to an embodiment of the present invention.

Referring to FIG. 4, the element 251 includes nine essential items (element types) required for location awareness. Furthermore, a value for each element is presented by ASCII code in accordance with a set conversion method. That is, a group including each element and a corresponding value includes a unique ASCII code value conversion method.

The value 252 includes a size, a semantic value and an ASCII code value conversion method corresponding to a corresponding element.

The element types include transmitted signal strength, antenna gain, antenna type, antenna-front horizontal azimuth angle, antenna antenna-front vertical azimuth angle, spatial information type, a spatial information feature, battery life, and temperature. In this case, the antenna gain and the antenna type correspond to the antenna shape of FIG. 4.

When a value for each element is transferred, a semantic value and an ASCII code value conversion method for representing the semantic value using an ASCII code value are used. In this case, the ASCII code value conversion method is a method of efficiently using data in the range of 0×21 to 0×7E, which is used in the present invention.

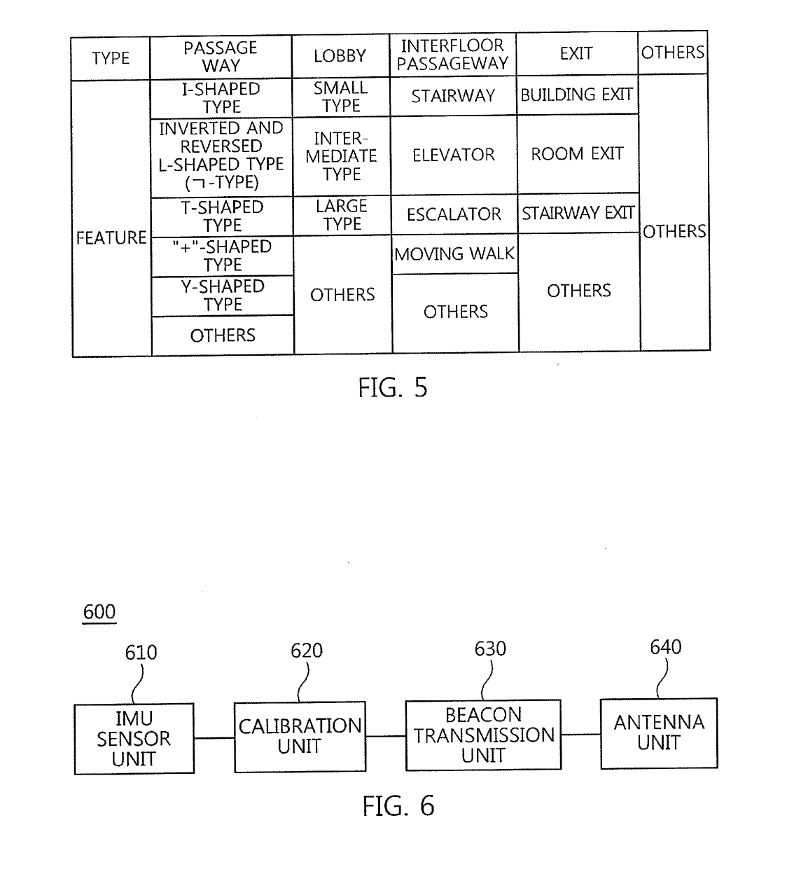

Next, values for the spatial information types and spatial information features of an element will be described in detail with reference to FIG. 5.

FIG. 5 is a diagram illustrating values for spatial information types and spatial information features according to an embodiment of the present invention.

Referring to FIG. 5, the spatial information types of an element refer to the types of spaces, and may be classified into a passage way, a lobby, an interfloor passageway, exit, and others.

The spatial information features of the element correspond to the subclasses of each spatial information type based on their detailed features. For example, when the spatial information type corresponds to a “passage way,” the spatial information type is subclassified into spatial information features, that is, an I-shaped type, an inverted and reversed L-shaped type (┐ type), a T-shaped type, a “+”-shaped type, a Y-shaped type, and others, according to the shape of the passage way.

Furthermore, the spatial information features for each of the spatial information types “lobby,” “interfloor passageway,” and “exit” are listed in FIG. 5.

Next, an apparatus and method for generating the antenna-front horizontal azimuth angle and antenna-front vertical azimuth angle of an element will be described in detail with reference to FIGS. 6 to 10.

When an antenna installed in a location beacon device is a patch antenna or a directional antenna, information about a direction in which the antenna has been installed is very important to location awareness or the measurement of an azimuth angle. Accordingly, the location beacon device should transmit the correct current state of the antenna including an antenna-front horizontal azimuth angle and an antenna-front vertical azimuth angle; otherwise a location awareness error of a terminal may be caused by the incorrect information.

That is, an azimuth angle transmission device capable of transmitting the correct state of an antenna, as illustrated in FIG. 6, is located in the location beacon device.

FIG. 6 is a diagram of an azimuth angle transmission device 600 according to an embodiment of the present invention.

Referring to FIG. 6, the azimuth angle transmission device 600 includes an inertial measurement unit (IMU) sensor unit 610, a calibration unit 620, a beacon transmission unit 630, and an antenna unit 640.

The IMU sensor unit 610 corresponds to a gyro sensor or an acceleration sensor, via which the direction information and acceleration information of a current location beacon is sensed.

The calibration unit 620 senses changes in the antenna-front horizontal azimuth angle and the antenna-front vertical azimuth angle based on the sensing results of the IMU sensor unit 610, and then calibrates the antenna-front horizontal azimuth angle and the antenna-front vertical azimuth angle using the values of the changes.

The beacon transmission unit 630 applies the antenna-front horizontal azimuth angle and the antenna-front vertical azimuth angle calibrated by the calibration unit 620 to the SSID (220 of FIG. 1), and transmits a beacon including the SSID via the antenna unit 640.

The antenna unit 640 is an antenna module that performs wireless transmission.

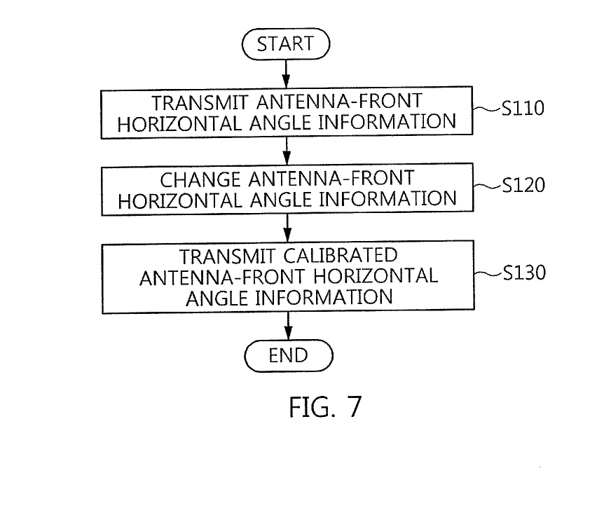

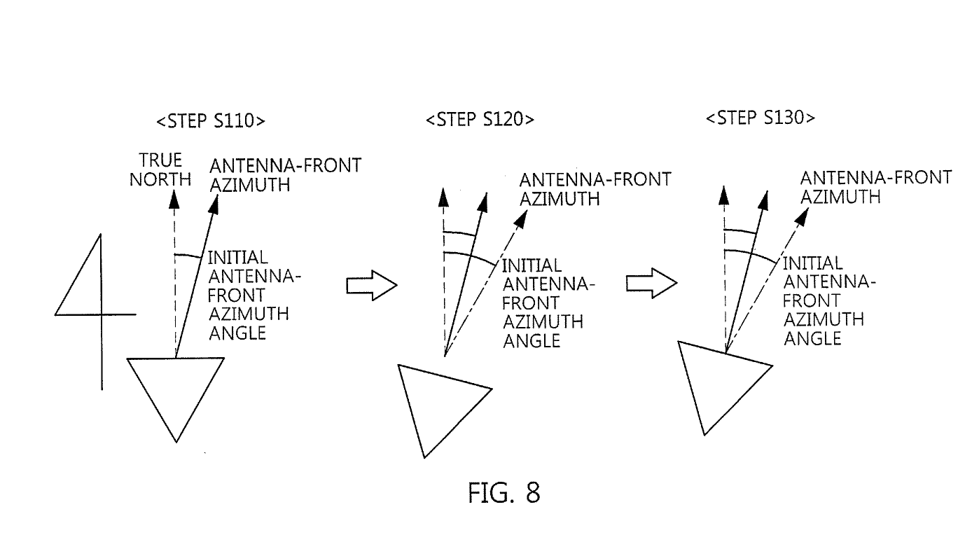

FIG. 7 is a flowchart of a method of generating an antenna-front horizontal azimuth angle according to an embodiment of the present invention, and FIG. 8 is a reference diagram illustrating the method of generating an antenna-front horizontal azimuth angle, which is illustrated in FIG. 7.

Referring to FIGS. 7 and 8, the azimuth angle transmission device (600 of FIG. 6) transmits antenna-front horizontal azimuth angle (hereinafter referred to as “antenna-front horizontal angle”) information at step S110. In this case, it is assumed that an antenna is installed at an angle of phi_init in the direction of true north first.

The value 252 of 0×44 (an ASCII code value) in the element 251 of the location-related information field 250 including antenna-front horizontal angle information transmitted by the beacon transmission unit 630 at step S110 is “phi_init.” In this case, the IMU sensor unit 610 stores the initial value G_int of a gyroscope corresponding to an internal variable value.

After the antenna-front horizontal angle information has been transmitted, as at step S110, the direction in which the antenna was installed may change for a specific reason, for example, wind, disturbance, or the like. In this case, the IMU sensor unit 610 measures the angle of the changed direction.

The azimuth angle transmission device (600 of FIG. 6) changes the antenna-front horizontal angle based on the angle measured by the IMU sensor unit 610 at step S120.

More specifically, the IMU sensor unit 610 senses a specific angle (for example, G_diff) by which the initial value G_int of a gyroscope corresponding to a gyro sensor has changed. Next, the IMU sensor unit 610 calculates “phi_diff” using the changed specific angle. In this case, the value of the gyroscope corresponds to “initial value G_int−changed specific angle G_diff.”

At step S130, the azimuth angle transmission device (600 of FIG. 6) transmits antenna-front horizontal angle information (phi_init−phi_diff) calibrated by the antenna-front horizontal angle information, for example, phi_diff, at step S120. In this case, the antenna-front horizontal angle corresponds to (phi_init−phi_diff), which in turn corresponds to the value 252 of 0×44 (an ASCII code value) in the element 251.

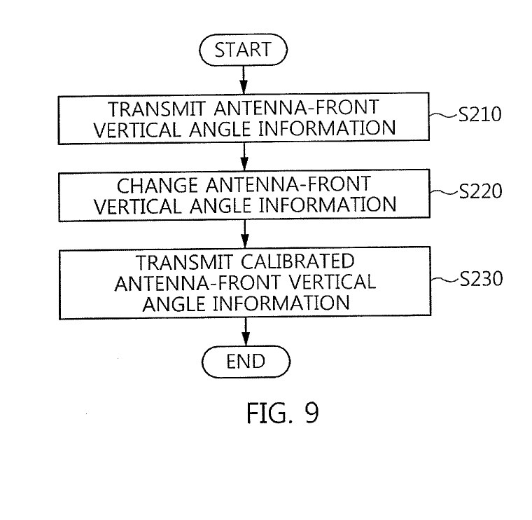

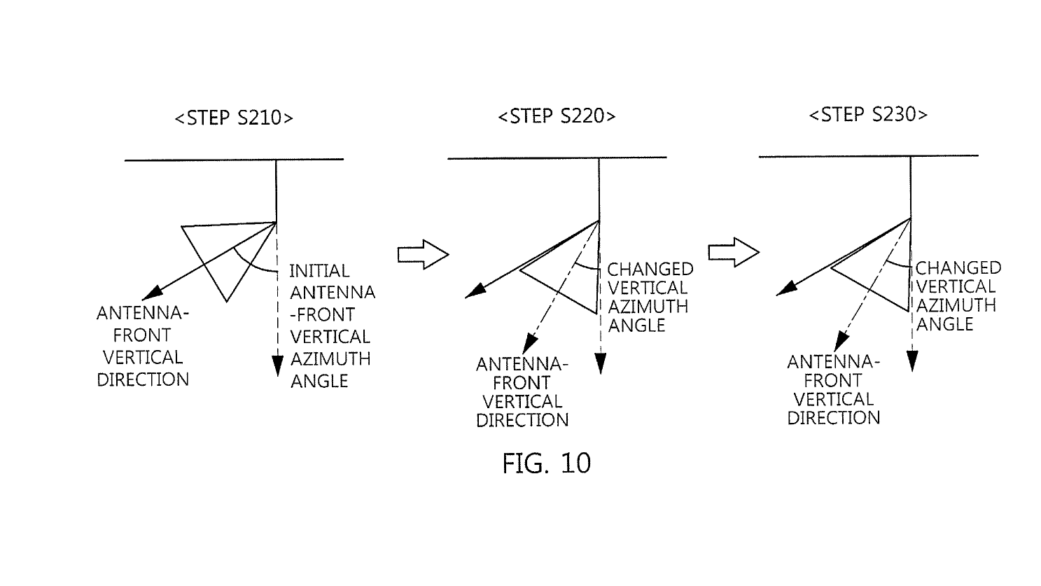

FIG. 9 is a flowchart of a method of generating an antenna-front vertical azimuth angle according to an embodiment of the present invention, and FIG. 10 is a reference diagram illustrating the method of generating an antenna-front vertical azimuth angle, which is illustrated in FIG. 9.

Referring to FIGS. 9 and 10, the azimuth angle transmission device (600 of FIG. 6) transmits antenna-front vertical azimuth angle (hereinafter referred to as “antenna-front vertical angle”) information at step S210. In this case, it is assumed that an antenna is installed at an angle of theta_init in a front vertical direction first.

The value 252 of 0×45 (an ASCII code value) in the element 251 of the location-related information field 250 including the antenna front vertical angle information transmitted by the beacon transmission unit 630 at step S210 is “theta_init.” In this case, the IMU sensor unit 610 stores the initial values Ax_init, Ay_init and Az_init of an accelerometer corresponding to internal variable values.

After the antenna-front vertical angle information has been transmitted, as at step S210, the direction in which the antenna was installed may change for a specific reason, for example, wind, disturbance or the like. In this case, the IMU sensor unit 610 measures the angle of the changed direction.

The azimuth angle transmission device (600 of FIG. 6) changes the antenna-front vertical angle based on the angle measured by the IMU sensor unit 610 at step S220.

More specifically, the IMU sensor unit 610 senses specific angles (for example, Ax_diff, Ay_diff, and Az_diff) by which the initial values Ax_init, Ay_init and Az_init of an accelerometer corresponding to an acceleration sensor have changed. Next, the IMU sensor unit 610 calculates “theta_diff” using the changed specific angle. In this case, the values of the accelerometer correspond to “initial values Ax_init, Ay_init and Az_init+changed specific angles Ax_diff, Ay_diff and Az_diff.”

At step S230, the azimuth angle transmission device (600 of FIG. 6) transmits antenna-front vertical angle information (theta_init+theta_diff) calibrated by the antenna-front vertical angle information, for example, theta_diff, at step S220. In this case, the antenna-front vertical angle corresponds to (theta_init+theta_diff), which in turn corresponds to the value 252 of 0×45 (an ASCII code value) in the element 251.

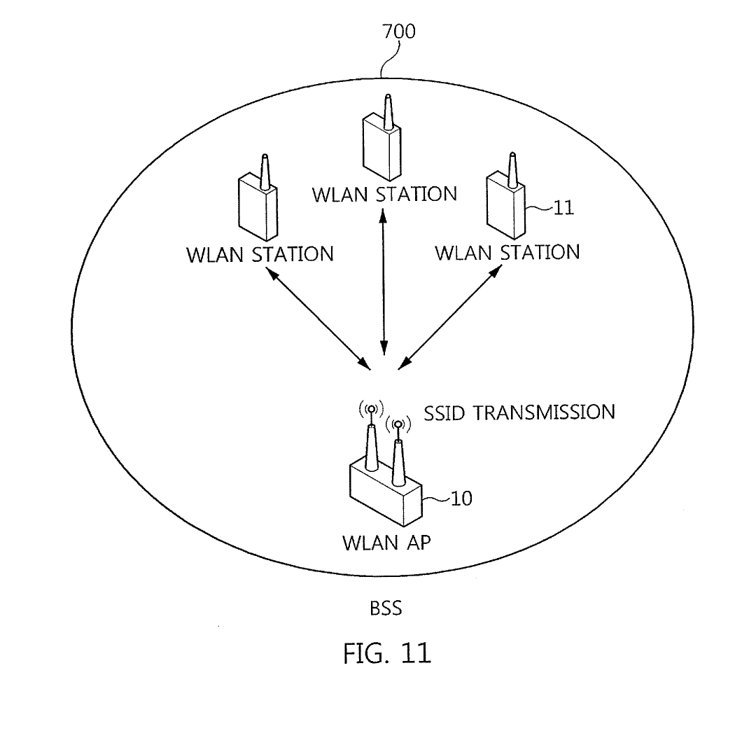

Next, a BSS area applied to an apparatus and method for automatically controlling a BSS area according to embodiments of the present invention will be described in detail with reference to FIGS. 11 to 13.

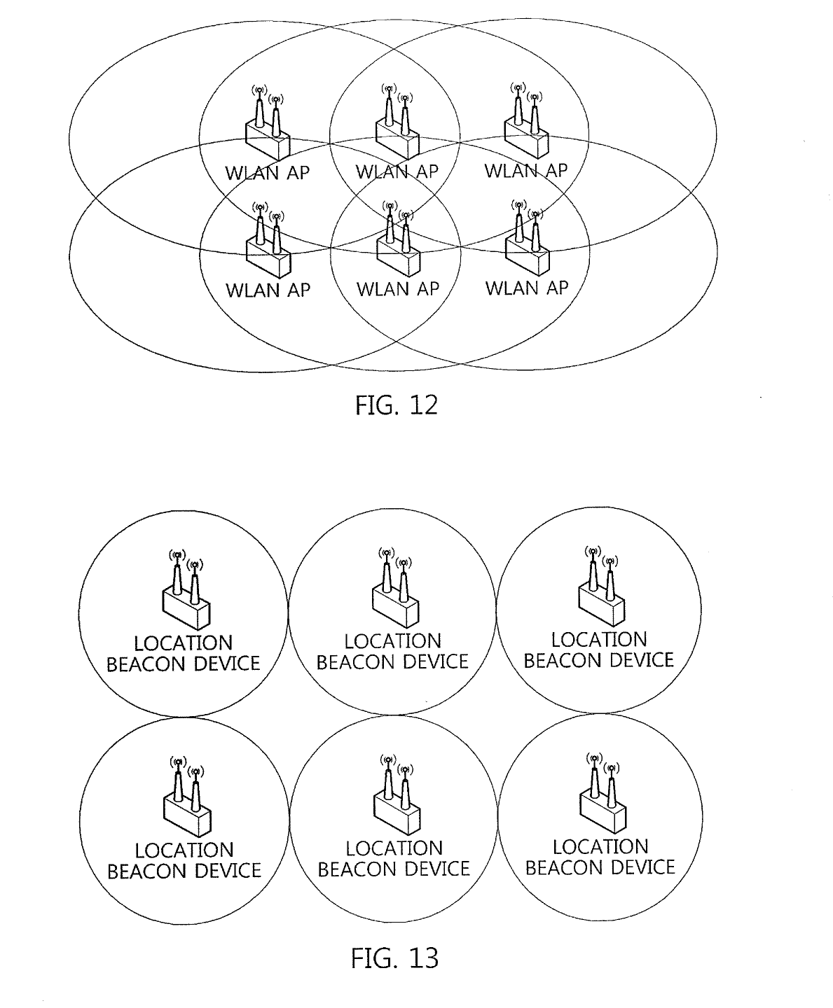

FIG. 11 is a diagram of a BSS area. FIG. 12 is a diagram of overlaps between BSS areas, and FIG. 13 is a diagram illustrating the minimization of overlaps between BSS areas.

Referring to FIG. 11, a basic service set (hereinafter referred to as “BSS”) area 700 includes a WLAN AP 10 configured to transmit the beacon 20 including the SSID 200 and a plurality of WLAN stations 11 configured to be connected to the WLAN AP 10.

A conventional WLAN AP sets the BSS area 700 as wide as possible, and does not require the function of minutely adjusting the area. When such conventional WLAN APs are closely deployed at intervals of a few meters, BSS overlap areas are generated, as illustrated in FIG. 12.

In general, a WLAN AP has difficulty controlling transmission power in a very low value range, and thus the size of BSS overlap areas is large. If transmission power can be controlled such that it starts to be set to a very low value, the size of BSS overlap areas can be minimized, as illustrated in FIG. 13.

From the point of view of a WLAN station that should achieve location awareness, when the number of BSS overlap areas is large, as illustrated in FIG. 12, RF spatial discrimination is poor, and thus it is difficult to achieve location awareness.

In contrast, in an environment, such as that illustrated in FIG. 13, RF spatial discrimination is desirable, and thus it is easy to achieve location awareness.

A location beacon device according to an embodiment of the present invention may be viewed as a type of WLAN AP that transmits the SSID 200 like the WLAN AP 10. The location beacon device can control its transmission power in a wide control range from a very low value to a high value, and can have minute control steps. For example, it can be considered that a device having a transmitted signal strength control range from −40 dBm to 10 dBm and control steps of 0.5 dB has sufficient requirements as a location beacon device.

When location beacon devices are closely deployed, as illustrated in FIG. 12, a control method capable of configuring BSS areas, as illustrated in FIG. 13, through the BSS area control of each device should be provided in order to improve the identification of RF spaces.

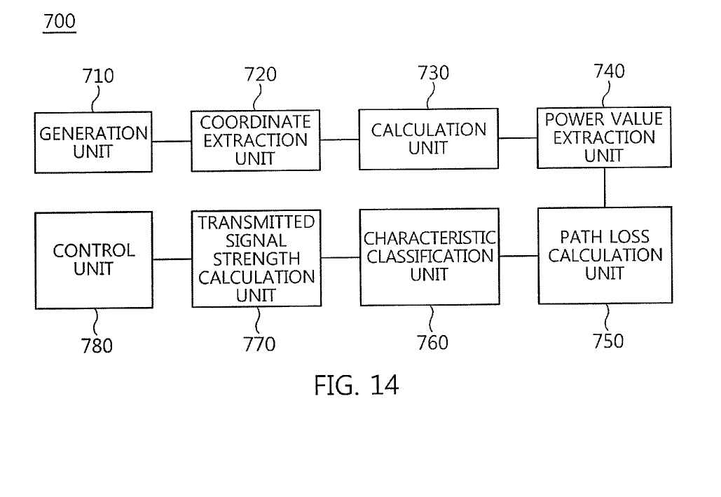

Next, an apparatus for automatically controlling a BSS area for a location beacon device will be described in detail with reference to FIG. 14.

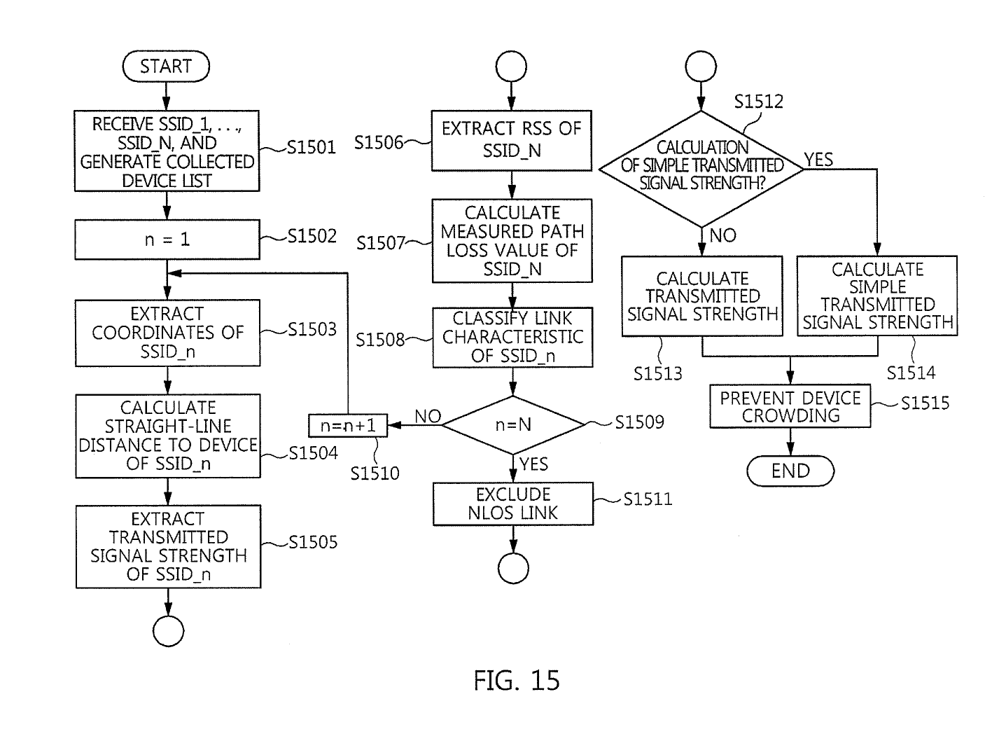

FIG. 14 is a diagram of an apparatus for automatically controlling a BSS area according to an embodiment of the present invention. Furthermore, FIG. 15 is a flowchart illustrating a method of automatically controlling a BSS area according to an embodiment of the present invention.

In general, when a plurality of location beacon devices is deployed in a limited space, location beacon signals are concurrently transmitted across the corresponding space. This means that BSS overlap areas are formed in a multiple manner in the limited space, and thus the RF characteristic information discrimination (hereinafter referred to as “RF spatial discrimination”) of a location beacon measurement value at a location where a location beacon signal is measured (a terminal reception location) within the space is poor. This situation frequently occurs when existing WLAN APs are employed. In this case, in order to achieve location awareness, an RF fingerprint method having a complicated calculation process is generally used.

For a terminal to easily identify its location without using a complicated calculation algorithm, the present invention proposes a BSS area automatic control method capable of improving the RF spatial discrimination of location beacon devices.

There are many cases where a large number of conventional location beacon devices are deployed. It is not efficient to control these devices in a central control method.

Accordingly, the apparatus for automatically controlling a BSS area for a location beacon device according to an embodiment of the present invention has a distributed control structure that does not require the central control of location beacon devices.

Referring to FIG. 14, an apparatus 700 for automatically controlling a BSS area includes a generation unit 710, a coordinate extraction unit 720, a calculation unit 730, a power value extraction unit 740, a path loss calculation unit 750, a characteristic classification unit 760, a transmitted signal strength calculation unit 770, and a control unit 780.

Referring to FIG. 15, the generation unit 710 receives SSIDs 200, and generates a collected device list based on the received SSIDs 200 at step S1501. As at step S1501, the apparatus 700 for automatically controlling a BSS area receives the SSIDs 200, thereby enabling corresponding location beacon devices to collect information about adjacent location beacon devices.

Furthermore, the generation unit 710 assumes that in the received SSIDs 200, the number of adjacent location beacon devices is N and sets “n” corresponding to an internal variable to 1 at step S1502.

At step S1503, the coordinate extraction unit 720 extracts the coordinates of SSID_n corresponding to an n-th device in the collected device list generated at step S1501.

At step S1504, the calculation unit 730 calculates the straight-line distance to a corresponding location beacon device using the coordinates of SSID_n extracted at step S1503.

The power value extraction unit 740 extracts the transmitted signal strength of an SSID corresponding to the n-th device S1505, extracts received signal strength (RSS) corresponding to the transmitted signal strength at step S1506.

At step S1507, the path loss calculation unit 750 calculates a measured path loss value using the transmitted signal strength and the RSS extracted at steps S1505 and S1506. In this case, the path loss calculation unit 750 calculates the measured path loss value PLₙ using Equation (1):

PLₙ=Pₜₓⁿ−Pᵣₓⁿ (1)

In Equation (1), PLₙ is a path loss in connection with the n-th device, Pₜₓⁿ is the transmitted signal strength of the n-th device, and Pᵣₓⁿ is the RSS of the n-th device.

At step S1508, the characteristic classification unit 760 classifies the characteristic Linkₙ of a link at step using the straight-line distance calculated S1504 and the measured path loss value calculated at step S1507. The characteristic Linkₙ of the link may be classified as a line-of-sight (LOS) link or a non-line-of-sight (NLOS) link. In this case, the LOS link corresponds to a line-of-sight link that is connected from a transmission antenna to a reception antenna along a straight line, and the NLOS link corresponds to a non-line-of-sight link.

The characteristic classification unit 760 classifies the characteristic of a link using Equation (2):

If PL_{free}(Rₙ)−Δ<PLₙ<PL_{free}(Rₙ)+Δ−Linkₙ=LOS

Else

−Linkₙ=NLOS (2)

In Equation (2), PL_{free}(Rₙ) is the free space loss at distance Rₙ, and Δ is a determination range.

The characteristic classification unit 760 classifies the characteristic Linkₙ of the link, as shown in Equation 2, and determines whether “n” is the same as the number N of adjacent location beacon devices at step S1509. If “n” is not the same as the number N of adjacent location beacon devices, 1 is added to n at step S1510, and the straight-line distance to the corresponding location beacon device is calculated again using the coordinates of SSID_n+1 at step S1503.

If “n” is the same as the number N of adjacent location beacon devices, the characteristic classification unit 760 excludes a device classified as an NLOS link from the collected device list at step S1511.

The transmitted signal strength calculation unit 770 calculates the transmitted signal strength Pₜₓ using a final collected device list corresponding to that of step S1511. In this case, the transmitted signal strength calculation unit 770 calculates the transmitted signal strength using a basic transmitted signal strength calculation method and a simpler transmitted signal strength calculation method.

More specifically, the transmitted signal strength calculation unit 770 determines whether to use the more transmitted signal strength calculation method at step S1512.

The transmitted signal strength calculation unit 770 obtains the transmitted signal strength Pₜₓ using Equation (3) corresponding to the basic transmitted signal strength calculation method at step S1513.

$$i = {arg}_{n} ( min ( {PL}_{free} ( {R}_{n} ) ) ) , \\ n = 1 , … , N \\ {i}_{} ( R ) = {PL}_{free} ( R ) + p {log}_{10} R \\ - {i}_{} ( R ) \text{:} Path loss model of i \text{-} th device \\ - p = \frac{{PL}_{n} - {PL}_{free} ( {R}_{i} )}{{log}_{10} R} \\ {P}_{tx} = ( α {R}_{i} ) + {P}_{desired rx} \qquad ( 3 )$$

In Equation (3), arg, is an argument that satisfies the above parenthesis. Furthermore, α is a value that is larger than 0 and smaller than 1. P_{desired rx} is desired RSS when RSS is measured at a location spaced apart by a distance of αR, for example, −95 dBM, which is sensitivity in 802.11n 1 Mbps mode.

The transmitted signal strength calculation unit 770 obtains the transmitted signal strength Pₜₓ using Equation (4) corresponding to the simpler transmitted signal strength calculation method at step S1514.

i=argₙ(mind(PL_{free}(Rₙ))),n=1, . . . ,N

Pₜₓ=PLᵢ+P_{desired rx} (4)

In Equation (4), P_{desired rx} is the strength of a signal that is transmitted to Pₜₓ and received by the i-th device.

When location beacon devices are unnecessarily closely deployed in a specific space, the control unit 780 prevents crowding by performing control so that all location beacon devices in the space do not operate and only a representative beacon device operates at step S1515. That is, the control unit 780 performs control at step S1515, thereby reducing unnecessary beacon transmissions and preventing the crowding of beacon devices in a BSS area.

The control unit 780 may prevent crowding in a BSS area using Equation (5):

If PLᵢ>PL_{upper bound} (5)
If its own NID<NID of i-th device

Referring to Equation (5), PL_{upper bound} is defined, and its beacon transmission is stopped if the measured path loss value of the i-th device is larger than PL_{upper bound} and its own NID is smaller than the NID of the i-th device.

As described above, the apparatus and method for automatically controlling a BSS area according to the embodiments of the present invention enable each location beacon device to become aware of the BSS wireless environment of adjacent location beacon devices and to control its BSS area in a distributed manner, thereby increasing RF spatial discrimination.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of controlling a basic service set (BSS) area, comprising:
receiving service set identifications (SSIDs) from location beacon devices, and generating a collected device list based on the received SSIDs;
extracting coordinates of an SSID corresponding to a specific location beacon device in the collected device list;
calculating a straight-line distance between the specific location beacon device and another location beacon device using the extracted coordinates of the SSID;
calculating a measured path loss value corresponding to the specific location beacon device;
classifying a characteristic of a link using the straight-line distance and the measured path loss value;
calculating transmitted signal strength using a final collected device list corresponding to results of the classification of the characteristic of the link; and
performing control using the transmitted signal strength so that a location beacon device other than the specific location beacon device is prevented from operating in a BSS area where the specific location beacon device is located.

2. The method of claim 1, wherein performing the control comprises setting the specific location beacon device as a representative location beacon device in the BSS area, and performing control so that only the set representative location beacon device operates, thereby preventing another location beacon from transmitting a beacon.

3. The method of claim 1, wherein calculating the measured path loss value comprises:
extracting transmitted signal strength and received signal strength (RSS) corresponding to the specific location beacon device; and
calculating the measured path loss value using the extracted transmitted signal strength and the RSS.

4. The method of claim 3, wherein calculating the measured path loss value comprises calculating a remainder obtained by subtracting the RSS from the transmitted signal strength as the measured path loss value.

5. The method of claim 1, wherein classifying the characteristic of the link comprises classifying the characteristic of the link as a line-of-sight (LOS) link or a non-line-of-sight (NLOS) link.

6. The method of claim 1, wherein the SSID comprises
delimiters indicative of a start and end of a location beacon corresponding to the location beacon device, an encrypt, a unique ID capable of identifying the SSID, an ID of the location beacon device, and a location-related information field.

7. The method of claim 6, wherein the location-related information field is a field in which location-related information is recorded, and is encrypted in accordance with the encrypt.

8. The method of claim 6, wherein the location-related information field comprises a collection of groups of an element representative of a type of location-related information and a value representative of a value corresponding to the location-related information.

9. The method of claim 8, wherein the element comprises transmitted signal strength, antenna gain, antenna type, antenna-front horizontal azimuth angle, antenna antenna-front vertical azimuth angle, spatial information type, a spatial information feature, battery life, and temperature.

10. The method of claim 9, wherein the antenna-front horizontal azimuth angle and antenna-front vertical azimuth angle of the element are used in such a way as to sense information about a direction in which an antenna in the location beacon device has been installed, to sense a change in an azimuth angle based on results of the sensing, and to apply an azimuth angle calibrated using the sensed change to the SSID.

11. The method of claim 8, wherein the value comprises a size, a semantic value and an ASCII code value conversion method corresponding to the corresponding element.

12. An apparatus for controlling a BSS area, comprising:
a generation unit configured to receive SSIDs from location beacon devices, and to generate a collected device list based on the received SSIDs;
a coordinate extraction unit configured to extract coordinates of an SSID corresponding to a specific location beacon device in the collected device list;
a calculation unit configured to calculate a straight-line distance between the specific location beacon device and another location beacon device using the extracted coordinates of the SSID;
a path loss calculation unit configured to calculate a measured path loss value corresponding to the specific location beacon device;
a characteristic classification unit configured to classify a characteristic of a link using the straight-line distance and the measured path loss value;
a transmitted signal strength calculation unit configured to calculate transmitted signal strength using a final collected device list corresponding to results of the classification of the characteristic of the link; and
a control unit configured to perform control using the transmitted signal strength so that a location beacon device other than the specific location beacon device is prevented from operating in a BSS area where the specific location beacon device is located.

13. The apparatus of claim 12, wherein the control unit sets the specific location beacon device as a representative location beacon device in the BSS area, and performs control so that only the set representative location beacon device operates, thereby preventing another location beacon from transmitting a beacon.

14. The apparatus of claim 12, further comprising a extraction unit configured to extract transmitted signal strength and RSS corresponding to the specific location beacon device; and
wherein the path loss calculation unit calculates the measured path loss value using the transmitted signal strength and RSS extracted by the extraction unit.

15. The apparatus of claim 12, wherein the characteristic classification unit classifies the characteristic of the link as an LOS link or an NLOS link.
